(19) United States
(12) Patent Application Publication
(10) Pub. No.: US 2015/0331772 A1
(43) Pub. Date: Nov. 19, 2015

(54) METHODS FOR UPDATING DIAGNOSTIC TOOLS ON A HARDWARE DEVICE AND DEVICES THEREOF

(71) Applicant: NetApp, Inc., Sunnyvale, CA (US)

(72) Inventors: Sreenivas Tallam, San Jose, CA (US); Curtis Anderson, Saratoga, CA (US); Gopakumar Thekkedath, Bangalore (IN)

(21) Appl. No.: 14/277,942

(22) Filed: May 15, 2014

(51) Int. Cl. G06F 11/273

(52) U.S. Cl. CPC G06F 11/273

(57) ABSTRACT

A method, non-transitory computer readable medium, and device that automatically updates diagnostic tools includes identifying hardware and software information associated with a hardware device coupled to the configuration management computing device. A rule is identified based on the identified hardware and software information associated with the hardware device. An executable diagnostic package is obtained based on information within the identified rule. An existing diagnostic package within the coupled hardware device is updated by replacing the existing diagnostic packaged within the coupled hardware device with the obtained executable diagnostic package.

### FIELD

This technology relates to diagnosis of a hardware device and, more particularly, methods for updating diagnostic tools on a hardware device and devices thereof.

### BACKGROUND

Traditionally a diagnostics software tool is a predefined package that is loaded as part of the operating system boot. As a result, a traditional diagnostics software tool cannot be entrusted to have all the capabilities required to diagnose technical errors encountered during the execution of the hardware device. Additionally, because of different parameters in different hardware devices, the frequent use of diagnostic software tools which are not specifically designed for those parameters can result in failures.

As a result, even with an existing software diagnostic tool loaded in a hardware device, all failures of the hardware device often cannot be pre-determined during the boot of the operating system. Instead, all the necessary pre-packaging testing tools that could diagnose or detect these failures in the hardware device often are not present during the time of booting of the operating system. Further, even if the additional diagnostics test tools are loaded in the hardware device, they may not work under certain run time conditions due to software bugs or errors within the diagnostic test tools or due to specific failure conditions which may prevent these diagnostic test tools from executing at the time of boot.

### SUMMARY

A method for automatically updating diagnostic tools on a hardware device includes a configuration management computing device for identifying hardware and software information associated with a hardware device coupled to the configuration management computing device. A rule is identified by the configuration management computing device based on the identified hardware and software information associated with the hardware device. An executable diagnostic package is obtained by the configuration management computing device based on information within the identified rule. An existing diagnostic package within the coupled hardware device is updated by the configuration management computing device by replacing the existing diagnostic packaged within the coupled hardware device with the obtained executable diagnostic package.

A non-transitory computer readable medium having stored thereon instructions for automatically updating diagnostic tools on a hardware device comprising executable code which when executed by a processor, causes the processor to perform steps including identifying hardware and software information associated with a hardware device coupled to the configuration management computing device. A rule is identified based on the identified hardware and software information associated with the hardware device. An executable diagnostic package is obtained based on information within the identified rule. An existing diagnostic package within the coupled hardware device is updated by replacing the existing diagnostic packaged within the coupled hardware device with the obtained executable diagnostic package.

A configuration management computing device includes a memory coupled to a processor configured to execute programmed instructions stored in the memory including identifying hardware and software information associated with a hardware device coupled to the configuration management computing device. A rule is identified based on the identified hardware and software information associated with the hardware device. An executable diagnostic package is obtained based on information within the identified rule. An existing diagnostic package within the coupled hardware device is updated by replacing the existing diagnostic packaged within the coupled hardware device with the obtained executable diagnostic package.

This technology provides a number of advantages including providing methods, non-transitory computer readable medium and devices for automatic verification of hardware devices. By way of example only, this technology addresses the limitation in these existing technologies, such as testing and diagnosing hardware devices only using pre-packaged test tools, by dynamically upgrading the hardware diagnostic software or tools during run-time. Additionally, this technology provides both flexibility and scalability that is required to meet the ever growing requirement of fully functional and expandable diagnostics test suite and tools during run-time. Furthermore, this technology does not require the hardware device or the operating system to reboot during the execution of the hardware diagnostics thereby significantly reducing the operating system down time, loss in existing working functionality of the diagnostics software or the operating system features. This technology also prevents the user of these hardware devices from manually upgrading the diagnostic test tools to understand the reason for the failure of the hardware device.

### BRIEF DESCRIPTION OF THE DRAWINGS

FIG. 1 is a block diagram of an environment with an exemplary configuration management computing device;

FIG. 2 is a block diagram of the exemplary configuration management computing device shown in FIG. 1;

FIG. 3 is a flow chart of an example of a method for updating diagnostic tools in a hardware device;

FIG. 4 is a flow chart of an example of a method for communicating between a kernel and a daemon process within the configuration management computing device;

FIG. 5 is an illustration of an exemplary rule;

FIG. 6 is a flow chart for an example of a method for identifying an executable diagnostic package; and

FIG. 7 illustrates exemplary contents of the identified executable diagnostic package.

### DETAILED DESCRIPTION

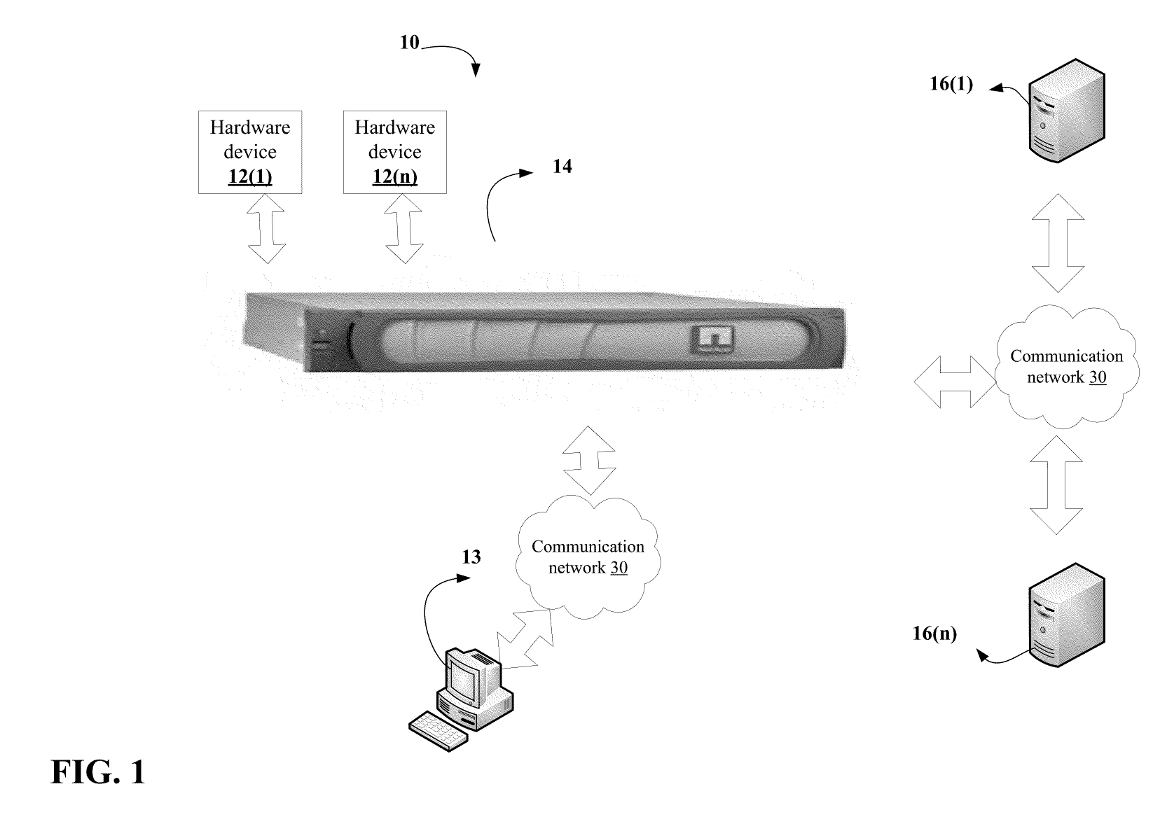

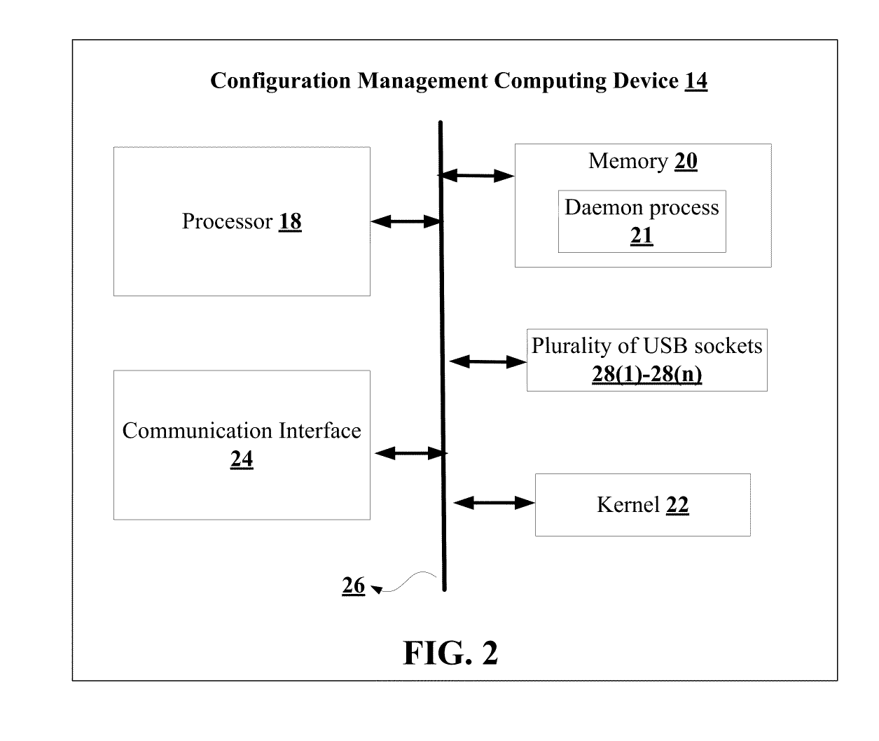

An environment 10 with an exemplary configuration management computing device 14 is illustrated in FIGS. 1-2. In this particular example, the environment 10 includes the configuration management computing device 14, a client computing device 13 and diagnostic servers 16(1)-16(n) coupled via one or more communication networks 30, although the environment could include other types and numbers of systems, devices, components, and/or other elements. In this example, the method for updating diagnostic tools in a hardware device is executed by the configuration management computing device 14 although the approaches illustrated and described herein could be executed by other systems and devices. The environment 10 may include other types and numbers of other network elements and devices, as is generally known in the art and will not be illustrated or described herein. This technology provides a number of advantages including providing methods, non-transitory computer readable medium and devices for updating diagnostic tools in a hardware device.

Referring more specifically to FIGS. 1-2, in this example the configuration management computing device 14 includes a processor 18, a memory 20, daemon process 21 within the memory 20, a kernel 22, and a communication interface 24, plurality of USB sockets 28(1)-28(n) which are coupled together by a bus 26, although the configuration management computing device 14 may include other types and numbers of elements in other configurations.

The processor 18 of the configuration management computing device 14 may execute one or more programmed instructions stored in the memory 20 for updating diagnostic tools in a hardware device as illustrated and described in the examples herein, although other types and numbers of functions and/or other operation can be performed. The processor 18 of the configuration management computing device 14 may include one or more central processing units (“CPUs”) or general purpose processors with one or more processing cores, such as AMD® processor(s), although other types of processor(s) could be used (e.g., Intel®).

The memory 20 of the configuration management computing device 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20. Additionally, as illustrated in FIG. 2, the memory 20 of the configuration management computing device 14 includes a daemon process 21, although the memory 20 could include other types and/or numbers of other processes, modules, programmed instructions and/or other data. As it would be appreciated by a person having ordinary skill in the art, the daemon process 21 is a computer program that runs as a background process. In this example, the daemon process 21 within the configuration management computing device 14 starts at boot time and assists the configuration management computing device 14 with responding to network requests, detecting insertion or removable of hardware devices to and from the configuration management computing device 14, although the daemon process 21 can perform other types or amounts of functions. Additionally, the daemon process 21 executing within the configuration management computing device 14 also assists the configuration management computing device 14 with configuring hardware devices using device managers, such as udevd. The device manager udevd of UNIX operating system is generally known to one of ordinary skill in the art and therefore will not be illustrated or described herein.

In this example as illustrated in FIG. 2, the configuration management computing device 14 further includes a kernel 22. The kernel 22 assists the configuration management computing device 14 with I/O management of the plurality of hardware devices 12(1)-12(n) when coupled via the plurality of USB sockets 28(1)-28(n), although the kernel 22 can perform other types or amounts of operations. By way of example only, the kernel can be a monolithic kernel or a microkernel.

The communication interface 24 of the configuration management computing device 14 operatively couples and communicates between the, client computing device 13, configuration management computing device 14 and the plurality of diagnostic servers 16(1)-16(n), which are all coupled together by the communication network 30, although other types and numbers of communication networks or systems with other types and numbers of connections and configurations to other devices and elements. By way of example only, the communication networks 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of USB sockets 28(1)-28(n) in the configuration management computing device 14 is configured to be communicably coupled with the plurality of hardware devices 12(1)-12(n). In this example, each of the USB sockets 28(1)-28(n) can be of standard USB 1.0 or 2.0 or 3.0, although each of the USB sockets could use other types and/or numbers of standards well known to one of ordinary skill in the art. Further in this example, each of the plurality of hardware devices 12(1)-12(n) are electronic devices having a male A-USB plug. By way of example only, the plurality of hardware devices 12(1)-12(n) could be memory drives, keyboards, speakers, scanners, printers, digital cameras, mobile phones, or external hard disks, although the plurality of hardware devices 12(1)-12(n) can be other types and/or numbers of devices. The plurality of the hardware devices 12(1)-12(n) are each coupled with the configuration management computing device 14 via one of the plurality of USB sockets 28(1)-28(n), although the plurality of hardware devices 12(1)-12(n) can be coupled to configuration management computing device 14 using other approaches.

Additionally, in this example the client computing device 13 includes a processor, a memory, and a communication interface, which are coupled together by a bus or other link, although other numbers and types of devices and/or nodes as well as other network elements could be used. In this example, the client computing device 13 assists a user with the use of the plurality of hardware devices 12(1)-12(n). The client computing device 13, in this example, may run interface applications to access the configuration management computing device 14 via communication network 30, although any other applications may execute on the client computing device 12.

Next, each of the plurality of diagnostic servers 16(1)-16(n) includes a processor, a memory, and a communication interface, which are coupled together by a bus or other link, although other types and/or numbers of systems, devices, components, elements, and/or nodes could be used. The plurality of diagnostic servers 16(1)-16(n) may store and provide content or other network resources in response to requests from the configuration management computing device 14 via the communication networks 30, for example, although other types and numbers of storage media in other configurations could be used. In particular, the diagnostic servers 16(1)-16(n) may each comprise diagnostic hardware and/or software packages that assist the configuration management computing device 14 with automatic verification of a hardware device. Various network processing applications, such as CIFS applications, NFS applications, HTTP Web Data storage device applications, and/or FTP applications, may be operating on the diagnostic servers 16(1)-16(n) and transmitting data (e.g., files or web pages) in response to requests from the configuration management computing device 14.

Although the exemplary network environment 10 with the plurality of hardware devices 12(1)-12(n), the client computing device 13, configuration management computing device 14, plurality of diagnostic servers 16(1)-16(n), and communication networks 30 are described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

An exemplary method for updating diagnostic tools in a hardware device will now be described with reference to FIGS. 1-7.

In step 305, one of the plurality of hardware devices 12(1)-12(n) is coupled to one of the plurality of USB sockets 28(1)-28(n) of the configuration management computing device 14. By way of example only, a network administrator may insert a USB memory drive, which is one of the plurality of hardware devices 12(1)-12(n), to one of the plurality of USB sockets 28(1)-28(n), although the plurality of hardware devices 12(1)-12(n) can be coupled to the USB sockets using other approaches.

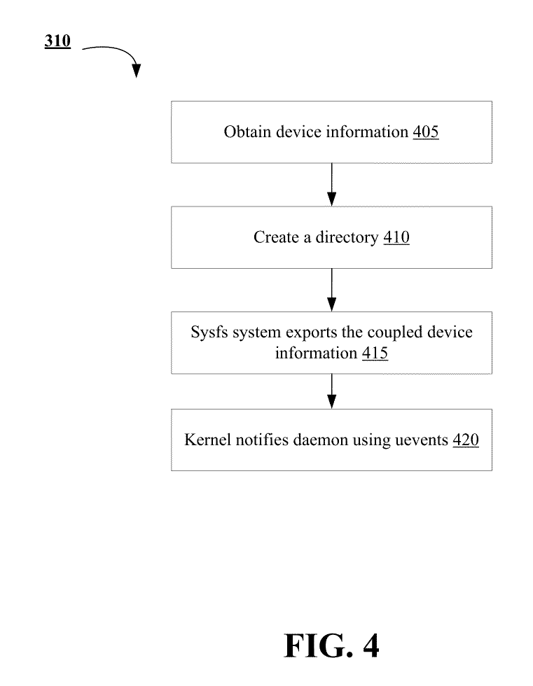

In step 310, the configuration management computing device 14 identifies that a new hardware device, i.e. one of the plurality of hardware devices 12(1)-12(n), is connected. In this example, the configuration management computing device 14 identifies that the new hardware device is coupled when the kernel 22 within the configuration management computing device 14 communicates with the coupled one of the plurality of hardware devices 12(1)-12(n), although other techniques can be used by the configuration management computing device 14 to detect a new hardware device being coupled to the configuration management computing device 14. Additionally, the kernel 22 within the configuration management computing device 14 further communicates with the daemon process 21 indicating that the new device has been coupled. One example of this technique of the kernel 22 communicating with the daemon process 21 will now be further illustrated with reference to the flow chart in FIG. 4.

In step 405, the kernel 22 obtains information from the coupled one of the plurality of hardware devices 12(1)-12(n). By way of example only, the information obtained by the kernel 22 includes a type, a name, and a serial number of the coupled one of the plurality of hardware devices 12(1)-12(n), although the kernel 22 within configuration management computing device 14 can obtain other types and/or amounts of information.

In step 410, the kernel 22 within the configuration management computing device 14 creates a directory name. In this example, the directory name is an exact match of the name of the coupled one of the plurality of hardware devices 12(1)-12(n), although the name could be different to the device name.

Next in step 415, the sysfs virtual system in UNIX operating system within the kernel 22 of the configuration management computing device 14 exports the obtained information from the coupled one of the plurality of hardware devices 12(1)-12(n) to the created directory name, although the obtained information can be stored at other locations.

In step 420, the kernel 22 notifies the daemon process 21 regarding the new hardware device, i.e., the coupled one of the plurality of hardware devices 12(1)-12(n), using a uevents function of UNIX operating system, although the daemon process can be notified using other types and/or numbers of approaches. The function of uevents is generally known to one of ordinary skill in the art and therefore will not be illustrated or described herein.

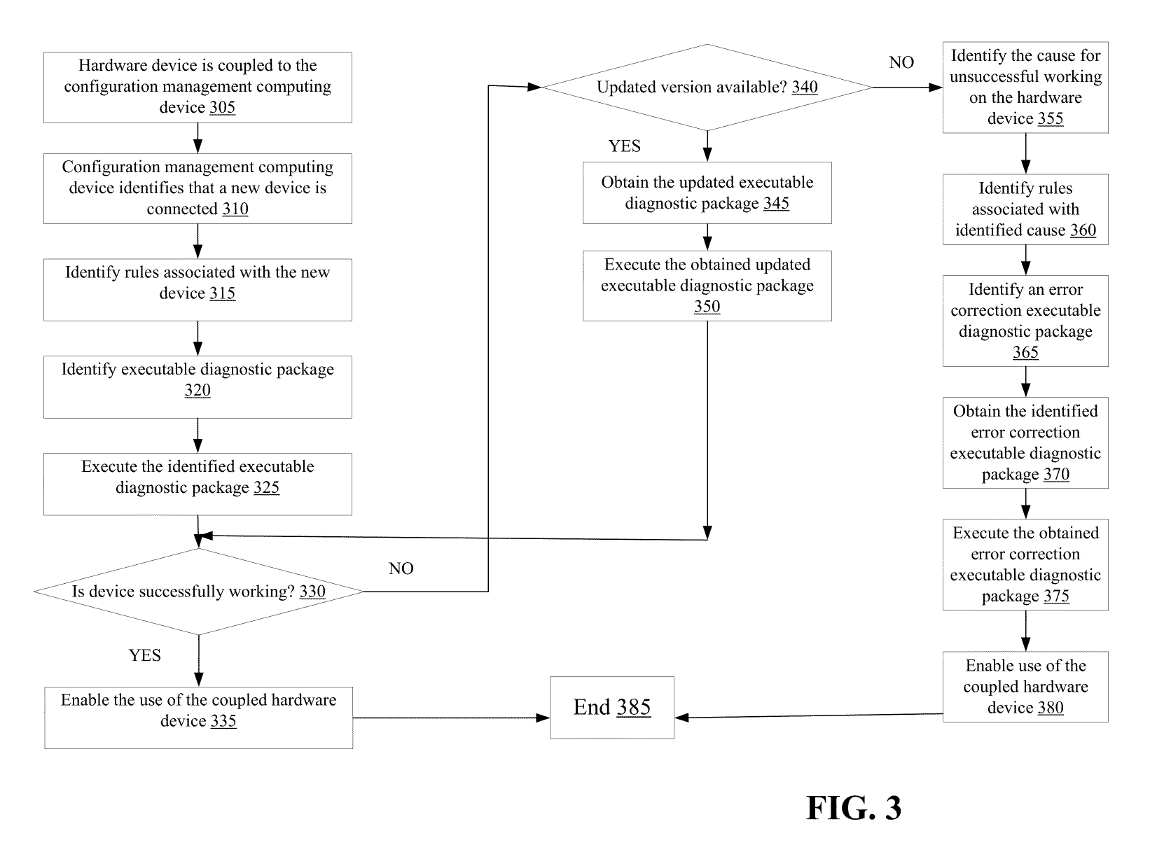

Referring back to FIG. 3, in step 315, the configuration management computing device 14 identifies one or more rules for the coupled one of the plurality of hardware devices 12(1)-12(n). In this example, once the daemon process 21 is notified by the kernel 22, then the daemon process 21 identifies one or more rules based on the obtained information associated with the coupled one of the plurality of hardware devices 12(1)-12(n) obtained in step 405 of FIG. 4. By way of example only, the daemon process 21 within the configuration management computing device 14 correlates the obtained name, type and serial number of the coupled one of the plurality of hardware devices 12(1)-12(n) against a rules table stored within the memory 20 to identify the one or more rules, although the daemon process 21 can use other types and/or approaches to identify the rules. Alternatively in another example, the daemon process 21 identifies the one or more rules within the /etc/udev/rules.d/*.rules file within the memory 20 of the configuration management computing device 14.

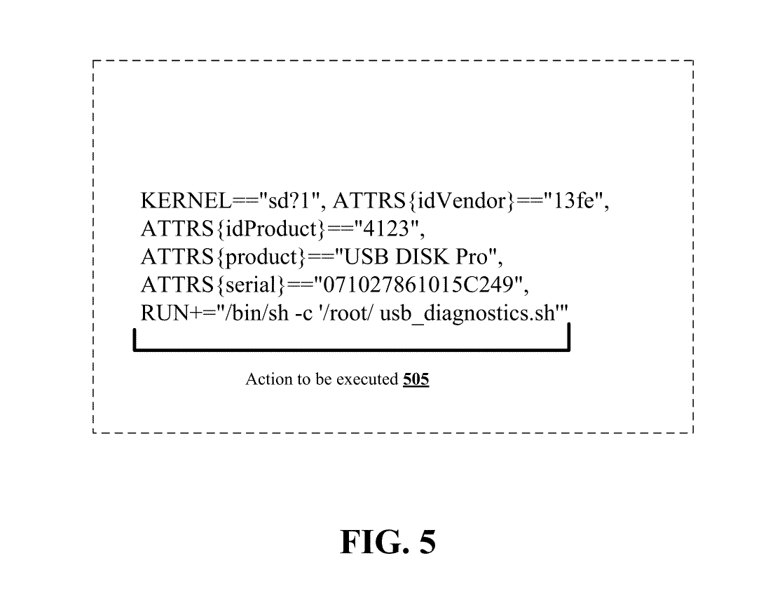

By way of example only, FIG. 5 illustrates an exemplary rule identified by the daemon process 21. In this example, this exemplary rule is identified and associated with the coupled one of the plurality of hardware device 12(1)-12(n) based on a Vendor identification number equal to 13fe, product identified number equal to 4123, product name equal to USB DISK Pro and the serial number equal to 071027861015C249. For purpose of further illustration of the rule, KERNEL in the exemplary rule illustrated in FIG. 5, indicates a match against the kernel name for the coupled one of the plurality of hardware devices 12(1)-12(n); ATTRS indicates matching a sysfs attribute of the coupled one of the plurality of hardware devices 12(1)-12(n), or a sysfs attribute of any of the parent devices; and RUN indicates action to be executed when the coupled one of the plurality of the hardware devices 12(1)-12(n) is detected by the kernel 22 of the configuration management computing device 14.

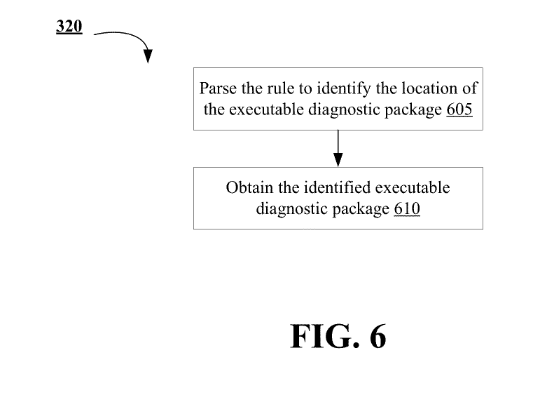

Next in step 320, the configuration management computing device 14 identifies an executable diagnostic package for the coupled one of the plurality of hardware devices 12(1)-12(n) based on the information present within the one or more identified rules, although the configuration management computing device 14 can identify the rules using other parameters and using other approaches. This method for identifying the executable diagnostic package will now be further illustrated with reference to the flow chart illustrated in FIG. 6.

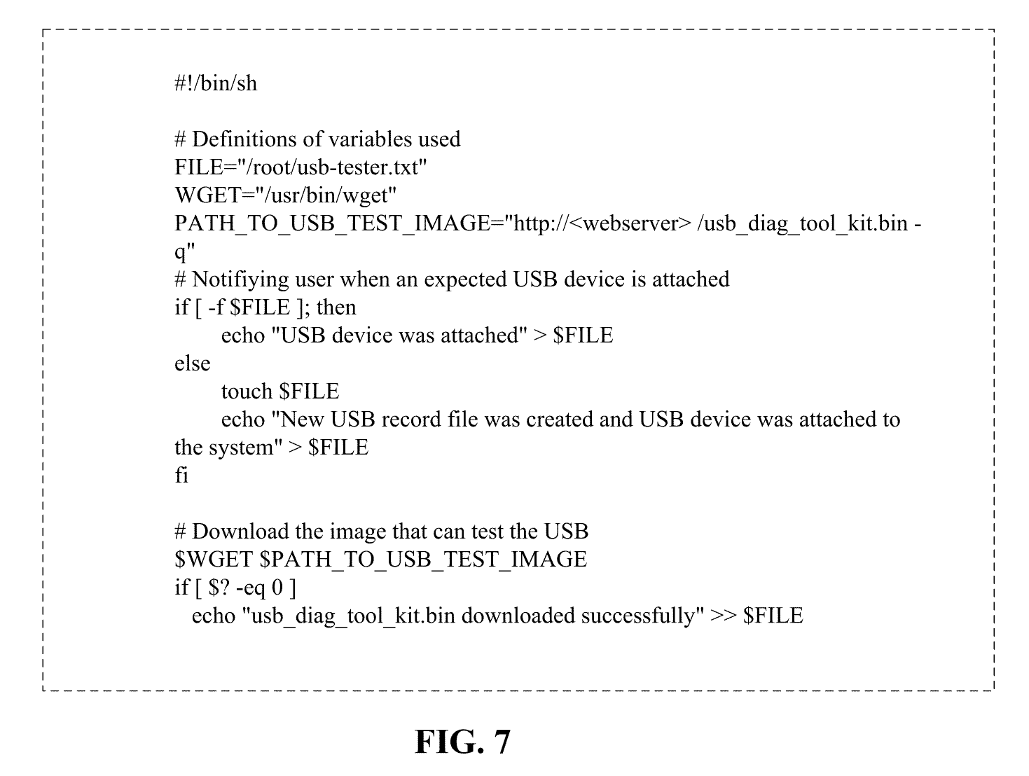

In step 605, the daemon process 21 parses the identified rule to identify information regarding the action that has to be executed on the coupled one of the plurality of hardware devices 12(1)-12(n). As previously illustrated in step 315 and with reference to FIG. 5, the action to be executed is indicated as separate information within the identified rule. By way of example only, “RUN+=”/bin/sh-c‘/root/usb_diagnostics.sh’” present within the exemplary rule illustrated in FIG. 5 indicates that the daemon process 21 has to identify an executable diagnostic package with name “usb_diagnostics.sh” from the file “/root” stored within the one of the plurality of diagnostic servers 16(1)-16(n). For purpose of further illustration, exemplary contents of the diagnostic package with name “usb_diagnostics.sh” are illustrated in FIG. 7. Alternatively in another example, the rule may also indicate to obtain the executable diagnostic package which could be stored within memory 20 of the configuration management computing device 14, although the rule could obtain the package from other locations.

Next in step 610, the daemon process 21 within the configuration management computing device 14 obtains the identified executable diagnostic package. By way of example only, the obtained executable diagnostic package is a executable file (binary file) with file name “usb_diag_tool_kit.bin” which can detect bad or corrupted data blocks within the coupled one of the plurality of hardware devices 12(1)-12(n) even before the coupled one of the plurality of hardware devices 12(1)-12(n) can be used. Additionally, once the daemon process 21 successfully obtains the identified executable diagnostic package, a notification indicating the successful completion is recorded within the file usb-tester. txt as illustrated in FIG. 7.

Alternatively in another example, the executable diagnostic package obtained by the daemon process 21 within the configuration management computing device 14 can be a performance package used to measure the performance of the coupled one of the plurality of hardware devices 12(1)-12(n). By way of example only, the performance package obtained by the daemon process 21 can be used to measure one or more of the I/O throughput, the CPU performance and/or the memory performance of the coupled one of the plurality of hardware devices 12(1)-12(n), although other types and/or numbers of parameters could be measured.

In yet another example, the executable package obtained by the daemon process 21 can be database package that can be used to track various errors associated with the coupled one of the plurality of hardware devices 12(1)-12(n) present within the file such as, filesyslog. These tracked errors can easily be provided to a user of the configuration management computing device 14 or the user of the client computing device 13 based on specific databases queries entered by the user.

In another example, the executable package obtained by the daemon process 21 within the configuration management computing device 14 can be compiler package. In this example, the complier package assists the user of the configuration management computing device 14 or the client computing device 13 to create custom diagnostics tests and utility tools on a currently executing operating system. These custom diagnostics tests and utility tools can then be executed to identify errors within the coupled one of the plurality of hardware devices 12(1)-12(n) without having to reboot either the client computing device 13 or the coupled one of the plurality of hardware devices 12(1)-12(n).

Alternatively in step 320, the configuration management computing device 14 can proceed to step 345 to obtain updated diagnostic package if the diagnostic package cannot be obtained based on the based on the information present within the one or more identified rules. Optionally, the configuration management computing device 14 can obtain the executable diagnostic package directly within memory 20 when the configuration management computing device 14 cannot identify the executable diagnostic package for the coupled one of the plurality of hardware devices 12(1)-12(n) based on the information present within the one or more identified rules.

Next in step 325 of FIG. 3, the configuration management computing device 14 executes the obtained executable diagnostic package. Prior to executing, the configuration management computing device 14 first updates the existing diagnostic package within the coupled one of the plurality of hardware devices 12(1)-12(n) by replacing the existing diagnostic package with the obtained executable diagnostic package. In this example, executing the obtained executable diagnostic package relates to compiling and executes the obtained executable diagnostic package within the terminal of the kernel 22. Additionally in this example, the configuration management computing device 14 while executing the obtained executable diagnostic package ensures that the client computing device 13 or the coupled one of the plurality of hardware devices 12(1)-12(n) is not required to be rebooted either during the executing or completion of the execution of the obtained executable diagnostic package.

Next in step 330, the configuration management computing device 14 determines if the coupled one of the plurality of hardware devices 12(1)-12(n) is successfully working without any error by checking for one or more operation criteria, although the configuration management computing device 14 can use other techniques to determine if the coupled one of the plurality of hardware devices 12(1)-12(n) is successfully working. In this example, when the daemon process 21 within the configuration management computing device 14 executes the obtained executable diagnostic package, the daemon process 21 checks for one or more operation criteria, such as bad or corrupt data blocks, or inaccessible data by way of example only, within the coupled one of the plurality of hardware devices 12(1)-12(n), although the daemon process 21 within the configuration management computing device 14 can check for other types and/or numbers of operation criteria. Additionally, while checking for one or more operation criteria, if the configuration management computing device 14 determines that one or more operation criteria is not satisfied, then the configuration management computing device identifies the dissatisfied operation criteria as one or more errors. By way of example only, if the configuration management computing device 14 determines that the data blocks within the coupled one of the plurality of hardware devices 12(1)-12(n) is corrupt, then the configuration management computing device 14 identifies that as one of the one or more errors.

Accordingly, when the daemon process 21 within the configuration management computing device 14 does not identify any error (which means that all the operation criteria has to be satisfied), then the coupled one of the plurality of hardware devices 12(1)-12(n) is determined to be successfully working. Optionally, the daemon process 21 can determine that the coupled one of the plurality of hardware devices 12(1)-12(n) to be successfully working when number of satisfied operation criteria is at least equal to a pre-defined threshold number of criteria. However, if the daemon process 21 within the configuration management computing device 14 identifies at least one error (which means, at least one of the one or more operation criteria is not satisfied) within the coupled one of the plurality of hardware devices 12(1)-12(n), then the coupled one of the plurality of hardware devices 12(1)-12(n) is identified as a not successfully working device. Accordingly, if the configuration management computing device 14 determines that the coupled one of the plurality of hardware devices 12(1)-12(n) is successfully working, then the Yes branch is taken to step 335. In step 335, the configuration management computing device 14 enables the use of the coupled one of the plurality of hardware devices 12(1)-12(n) and the exemplary method ends in step 385.

However if back in step 330 the configuration management computing device 14 determines that the coupled one of the plurality of hardware devices 12(1)-12(n) is not successfully working, then the No branch is taken to step 340. In step 340, the configuration management computing device 14 determines whether an updated version of the obtained executable diagnostic package is available. By way of example only, the daemon process 21 within the configuration management computing device 14 once again obtains the executable diagnostic package from the memory location indicated within the rule. Next, the daemon process 21 compares the previously obtained executable diagnostic package and the currently obtained executable diagnostic package to determine any for any changes or for one or more other relevant executable diagnostic packages. If the daemon process 21 within the configuration management computing device 14 identifies changes and/or one or more other relevant executable diagnostic packages, then the configuration management computing device 14 identifies there is an updated version of the executable diagnostic package and/or one or more other relevant executable diagnostic packages available. However, if there are no changes identified in the comparison, then the updated or other relevant executable diagnostic package is determined to be unavailable. By checking for the availability of the most updated or other relevant executable diagnostic package, the technology disclosed herein is able to more often accurately diagnosis a failure or other error in the coupled one of the plurality of hardware devices 12(1)-12(n). By way of example only, the script within the executable diagnostic package may be frequently updated based on the changing evolving technology of diagnosing hardware device.

Accordingly, if the configuration management computing device 14 determines that the updated executable diagnostic package or one or more other relevant executable diagnostic packages is available, then the Yes branch is taken to step 345. In step 345, the daemon process 21 within the configuration management computing device 14 obtains the updated executable diagnostic package or one or more other relevant executable diagnostic packages from the location indicated within the rule.

Next in step 350, the daemon process 21 executes the updated executable diagnostic package or one or more other relevant executable diagnostic packages using the technique illustrated in step 325 and the exemplary flow proceeds back to step 330 to determine whether the coupled one of the plurality of hardware devices 12(1)-12(n) is working successfully. Again as previously illustrated, the configuration management computing device 14 ensures that the client computing device 13 or the coupled one of the plurality of hardware devices 12(1)-12(n) is not required to be rebooted either during or after the execution of the updated executable diagnostic package or one or more other relevant executable diagnostic packages.

However, back in step 340 if the configuration management computing device 14 determines that the updated executable diagnostic package is not available, then the No branch is taken to step 355. In step 355, the daemon process 21 within the configuration management computing device 14 identifies the cause or reason for unsuccessful working of the coupled one of the plurality of hardware devices 12(1)-12(n). As previously illustrated back in step 330, the daemon process 21 upon executing the updated executable diagnostic package, the one or more other relevant executable diagnostic packages, or the non-updated executable diagnostic package, the daemon process can identify the cause or reason for unsuccessful working of the coupled one of the plurality of hardware devices 12(1)-12(n). By way of example only, the reason or cause for unsuccessful working of the coupled one of the plurality of hardware devices 12(1)-12(n) can be one or more of bad or corrupt data blocks, or inaccessible data within the coupled one of the plurality of hardware devices 12(1)-12(n), although the daemon process 21 can identify other types and/or numbers of causes or other reasons for unsuccessful working of the coupled one of the plurality of hardware devices 12(1)-12(n).

In step 360, the daemon process 21 within the configuration management computing device 14 identifies one or more rules associated with the identified cause or other reason. By way of example only, the daemon process 21 correlates the identified cause or other reason against a table including the corresponding rules stored within the memory 20, although the daemon process 21 can use other approaches to identify the rules.

In step 365, the daemon process 21 identifies one or more error correction executable diagnostic packages based on the one or more identified rules using the technique previously illustrated in step 320.

Alternatively in another example, the daemon process 21 may provide a notification to the on the display device of the client computing device 13 indicating that the coupled one of the plurality of hardware devices 12(1)-12(n) may not work successfully or other feedback and the exemplary method may end. By way of example only, the daemon process 21 may provide notification to the client computing device 13 when there is a hardware problem with the coupled one of the plurality of hardware devices 12(1)-12(n) as the hardware problem cannot be fixed using the one or more error correction executable diagnostic packages.

In step 370, the daemon process 21 within the configuration management computing device 14 obtains the identified one or more error correction executable diagnostic packages based on the identified rule using the technique previously illustrated in step 345.

In step 375, the daemon process 21 within the configuration management computing device 14 executes the obtained one or more error correction executable diagnostic package using the technique illustrated in step 325. Upon executing the one or more obtained error correction executable diagnostic packages, then the identified causes or errors within the coupled one of the plurality of hardware devices 12(1)-12(n) can be corrected. Again as previously illustrated, the configuration management computing device 14 ensures that the client computing device 13 or the coupled one of the plurality of hardware devices 12(1)-12(n) is not required to be rebooted either during or after the execution of the error correction executable diagnostic package.

In step 380, the configuration management computing device 14 enables the use of the coupled one of the plurality of hardware devices 12(1)-12(n) and the exemplary method ends in step 385.

Optionally in another example, the configuration management computing device 14 can obtain and execute the one or more executable diagnostic packages at frequent interval of times to ensure proper working of the coupled one of the plurality of hardware devices 12(1)-12(n). By way of example only, the daemon process 21 within the configuration management computing device 14 can obtain the one or more executable diagnostic packages once in every set time interval, e.g. once a week, using the approaches illustrated and described above while the coupled one of the plurality of hardware devices 12(1)-12(n) is being used. Alternatively, the configuration management computing device 14 can scan each of the plurality of hardware devices 12(1)-12(n) coupled to the configuration management computing device 14 once in every set time interval, e.g. once a week, to check if an updated executable diagnostic package is required to be downloaded using the technique illustrated in step 340. Accordingly, if the configuration management computing device 14 determines that an updated executable diagnostic package is required, then the configuration management computing device 14 can obtain the updated executable diagnostic package using technique illustrated in step 345. Upon obtaining, the configuration management computing device 14 can replace the existing diagnostic package within the coupled one of the plurality of hardware devices 12(1)-12(n) with the updated executable diagnostic package.

Accordingly, as illustrated and described with reference to the examples herein, this technology provides methods, non-transitory computer readable medium and devices that dynamically upgrade the hardware diagnostic software or tools during run-time. Additionally, this technology provides both flexibility and scalability that is required to meet the ever growing requirement of fully functional and expandable diagnostics test suite and tools during run-time.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for automatically updating diagnostic tools on a hardware device, the method comprising:
identifying, by a configuration management computing device, hardware and software information associated with a hardware device coupled to the configuration management computing device;
identifying, by a configuration management computing device, a rule associated with the coupled hardware device based on the identified hardware and software information associated with the hardware device;
obtaining, by the configuration management computing device, an executable diagnostic package based on information within the identified rule; and
updating, by the configuration management computing device, an existing diagnostic package within the coupled hardware device by replacing the existing diagnostic packaged within the coupled hardware device with the obtained executable diagnostic package.

2. The method as set forth in claim 1 further comprising executing, by the configuration management computing device, the obtained executable diagnostic package to determine when the coupled hardware device satisfies one or more operational criteria without rebooting either the client computing device or the coupled hardware device.

3. The method as set forth in claim 2 further comprising verifying, by the configuration management computing device, the coupled hardware device to be valid when the coupled hardware device is determined to satisfy all of the one or more operational criteria.

4. The method as set forth in claim 2 further comprising:
identifying, by the configuration management computing device, one or more errors with the coupled hardware device based on the obtained executed diagnostic package when the coupled hardware device is determine not to satisfy the one or more operation criteria; and
identifying, by the configuration management computing device, an error correction diagnostic package based on the identified one or more errors.

5. The method as set forth in claim 4 further comprising:
obtaining, by the configuration management computing device, the identified error correction diagnostic package; and
executing, by the configuration management computing device, the obtained error correction diagnostic package without rebooting the coupled hardware device or the client computing device to enable the coupled hardware device to work successfully.

6. The method as set forth in claim 4 further comprising:
determining, by the configuration management computing device, availability of an updated executable diagnostic package or one or more relevant diagnostic packages associated with the obtained executable diagnostic package;
obtaining, by the configuration management computing device, the updated executable diagnostic package or the one or more relevant diagnostic packages when the updated executable diagnostic package or the one or more relevant diagnostic packages is determined to be available; and
executing, by the configuration management computing device, the obtained updated executable diagnostic package or the one or more relevant diagnostic packages without rebooting the coupled hardware device or the client computing device to determine for the successful working of the coupled hardware device.

7. A non-transitory computer readable medium having stored thereon instructions for automatically updating diagnostic tools on a hardware device comprising executable code which when executed by a processor, causes the processor to perform steps comprising:
identifying hardware and software information associated with a hardware device coupled to a configuration management computing device;
identifying a rule associated with the coupled hardware device based on the identified hardware and software information associated with the hardware device;
obtaining an executable diagnostic package based on information within the identified rule; and
updating an existing diagnostic package within the coupled hardware device by replacing the existing diagnostic packaged within the coupled hardware device with the obtained executable diagnostic package.

8. The medium as set forth in claim 7 further comprising executing the obtained executable diagnostic package to determine when the coupled hardware device satisfies one or more operational criteria without rebooting either the client computing device or the coupled hardware device.

9. The medium as set forth in claim 8 further comprising verifying the coupled hardware device to be valid when the coupled hardware device is determined to satisfy all of the one or more operational criteria.

10. The medium as set forth in claim 8 further comprising:
identifying one or more errors with the coupled hardware device based on the obtained executed diagnostic package when the coupled hardware device is determine not to satisfy the one or more operation criteria; and
identifying an error correction diagnostic package based on the identified one or more errors.

11. The medium as set forth in claim 10 further comprising:
obtaining the identified error correction diagnostic package; and
executing the obtained error correction diagnostic package without rebooting the coupled hardware device or the client computing device to enable the coupled hardware device to work successfully.

12. The medium as set forth in claim 10 further comprising:
determining, by the configuration management computing device, availability of an updated executable diagnostic package or one or more relevant diagnostic packages associated with the obtained executable diagnostic package;
obtaining, by the configuration management computing device, the updated executable diagnostic package or the one or more relevant diagnostic packages when the updated executable diagnostic package or the one or more relevant diagnostic packages is determined to be available; and
executing, by the configuration management computing device, the obtained updated executable diagnostic package or the one or more relevant diagnostic packages without rebooting the coupled hardware device or the client computing device to determine for the successful working of the coupled hardware device.

13. A configuration management computing device comprising:
a processor;
a memory, wherein the memory coupled to the processor which are configured to execute programmed instructions stored in the memory comprising:
identifying hardware and software information associated with a hardware device coupled to the configuration management computing device;
identifying a rule associated with the coupled hardware device based on the identified hardware and software information associated with the hardware device;
obtaining an executable diagnostic package based on information within the identified rule; and
updating an existing diagnostic package within the coupled hardware device by replacing the existing diagnostic packaged within the coupled hardware device with the obtained executable diagnostic package.

14. The device as set forth in claim 13 wherein the processor is further configured to execute programmed instructions stored in the memory further comprising executing the obtained executable diagnostic package to determine when the coupled hardware device satisfies one or more operational criteria without rebooting either the client computing device or the coupled hardware device.

15. The device as set forth in claim 14 wherein the processor is further configured to execute programmed instructions stored in the memory further comprising verifying the coupled hardware device to be valid when the coupled hardware device is determined to satisfy all of the one or more operational criteria.

16. The device as set forth in claim 14 wherein the processor is further configured to execute programmed instructions stored in the memory further comprising:
identifying one or more errors with the coupled hardware device based on the obtained executed diagnostic package when the coupled hardware device is determine not to satisfy the one or more operation criteria; and
identifying an error correction diagnostic package based on the identified one or more errors.

17. The device as set forth in claim 16 wherein the processor is further configured to execute programmed instructions stored in the memory further comprising:
obtaining the identified error correction diagnostic package; and
executing the obtained error correction diagnostic package without rebooting the coupled hardware device or the client computing device to enable the coupled hardware device to work successfully.

18. The device as set forth in claim 16 wherein the processor is further configured to execute programmed instructions stored in the memory further comprising:
determining availability of an updated executable diagnostic package or one or more relevant diagnostic packages associated with the obtained executable diagnostic package;
obtaining the updated executable diagnostic package or the one or more relevant diagnostic packages when the updated executable diagnostic package or the one or more relevant diagnostic packages is determined to be available; and
executing the obtained updated executable diagnostic package or the one or more relevant diagnostic packages without rebooting the coupled hardware device or the client computing device to determine for the successful working of the coupled hardware device.
